(19) United States
(12) Patent Application Publication
(10) Pub. No.: US 2026/0133283 A1
(43) Pub. Date: May 14, 2026

(54) APPARATUS AND METHOD FOR BUILT-IN COMPENSATION FOR I/Q MISMATCH AND DC OFFSETS IN A RADAR SYSTEM

(71) Applicant: Samsung Electronics Co., Ltd., Gyeonggi-do (KR)

(72) Inventors: Pranav DAYAL, San Diego, CA (US); Gennady FEYGIN, San Diego, CA (US); Oren Eytan ELIEZER, San Diego, CA (US)

(21) Appl. No.: 19/371,800

(22) Filed: Oct. 28, 2025

Related U.S. Application Data
(60) Provisional application No. 63/718,298, filed on Nov. 8, 2024.

(51) Int. Cl. G01S 7/35

(52) U.S. Cl. CPC G01S 7/354; G01S 7/358

(57) ABSTRACT

A system and a method are disclosed for the mitigation of I/Q mismatches and DC offsets in a radar's quadrature receiver based on built-in measurements, i.e. without requiring external test equipment for calibration. The method is based on digitally processing the impaired signal in the receiver's digital front-end, which results from the transmitter's output being looped-back into in the receiver's input via a path with a certain delay. Multiple embodiments are disclosed to determine the extent of the receiver's amplitude and phase mismatches, as well as the dc offsets in its two branches, based either on multiple iterations or a single iteration. Once determined, the receiver is capable of removing the mismatch errors and the dc offsets from the signals it receives during self-testing and calibration of the transmitter's phase shifter, as well as during normal operation when receiving signals reflected from targets.

### CROSS-REFERENCE TO RELATED APPLICATION

This application claims the priority benefit under 35 U.S.C. § 119(e) of U.S. Provisional Application No. 63/718,298, filed on Nov. 8, 2024, the disclosure of which is incorporated by reference in its entirety as if fully set forth herein.

### TECHNICAL FIELD

The disclosure generally relates to radar systems. More particularly, the subject matter disclosed herein relates to built-in compensation of in-phase and quadrature-phase (I/Q) mismatch and cancellation of offsets in receivers of radar systems.

### SUMMARY

Frequency-modulated continuous wave (FMCW) radar is a distance and velocity ranging system used in a wide range of applications, including automotive radar. A multiple-input-multiple-output (MIMO) radar system is based on multiple paths of transmission and reception, which when operating together, can enhance performance of the radar system (e.g., resolution). The present disclosure addresses a problem in radar receivers in which a quadrature receiver is employed, having in-phase (I) and quadrature-phase (Q) paths. Ideally, the I and Q paths are perfectly orthogonal to each other, based on two local-oscillator signals that are 90° apart in phase, and have the same amplitude gain.

In practice, however, both of these parameters experience non-idealities, such as the actual angle between the I and Q paths being 90°+φ, i.e., the receiver is said to experience a phase mismatch of φ degrees. Similarly, while the gain in the I path is A dB, the gain in the Q path is (A+g) dB, i.e., having a gain mismatch of g dB. Consequently, an image signal is generated in the complex receiver and this non-ideality can be quantified based on its relative level with respect to the desired signal in terms of an image-rejection-ratio (IRR).

For example, for a tone located at frequency Δf after down-conversion in the receiver, there will appear an image tone at frequency −Δf. The strength and the phase of the image tone will be a function of the gain and the phase mismatches. The ratio between the power of the desired tone and that of the image tone is known as an image-rejection-ratio (IRR). In a radar system, a receiver with low gain and phase mismatches is desired (high IRR) for two reasons: (1) The receiver is used for self-calibration of the transmitter phase shifters, which should be set to a high standard of accuracy to support radar modulation schemes such as Doppler-division multiplexing (DDM); and (2) A poor IRR will cause an interfering signal from the negative frequency spectrum to have presence in the positive frequency spectrum, potentially producing false targets or an increase in noise floor.

Accordingly, an aspect of the present disclosure is to provide a mechanism to measure the mismatch in gain and phase of a receiver's analog front-end (AFE) so that the gain and phase mismatches can be compensated for in the digital portion of the receiver, i.e., the receiver's digital front-end (DFE), thus effectively mitigating the effects of poor IRR mentioned above and allowing for accurate characterization and calibration of the phase-shifters in the radar's transmission paths, based on a loop-back path that feeds their signals into the receiver.

According to an embodiment, a method is provided for forming a TX-to-RX loopback path inside a transceiver of a radar system and transmitting a chirp signal, as in standard radar operation, to be used as a test signal for the receiver when it is being calibrated. In a later step, this same signal is used for the evaluation of the transmitter against the calibrated/compensated receiver. The chirp signal mixes with a delayed version of itself in the radar receiver, as in normal operation of the radar system, resulting in a beat frequency tone that corresponds to the delay. The beat frequency is located at a positive frequency offset, Δf, in complex baseband representation, since the delay is positive.

In addition to the beat frequency in the positive spectrum, due to I/Q gain and phase mismatches, an image is produced at the negative of the beat frequency, −Δf. This image is smaller in amplitude than the main beat frequency signal and its phase is rotated with respect to the beat frequency.

Complex DC offset (i.e., independent levels of DC offset in the I and Q branches) is also present in the receiver due to inevitable offsets in the analog baseband circuitry, as well as in the analog-to-digital converters (ADCs). Therefore, the sum of the beat frequency, its image, DC offsets and thermal noise are to be considered in the processing of the digitized I and Q signals.

According to another embodiment, a method is provided for estimating amplitude and phase of a beat frequency, amplitude and phase of its image, and amplitude and phase of a complex DC offset. An algorithm or function of the method allows for the determination of an amplitude mismatch g and a phase mismatch #, which are then fed to the digital portion of a receiver, where a correction for these mismatches is applied digitally (i.e. without having to apply compensations in the analog circuitry where the mismatches are experienced).

The values of amplitude and phase mismatches in the system computed from the algorithm or function may be applied through a digital IQ Mismatch Correction (IQMC) function in the receiver's digital front end (DFE). The complex DC offset is digitally compensated for in a DC offset correction (DCOC) function inside DFE. The overall receiver, combining the AFE with the DFE, where corrections are applied, exhibits much lower IQMM, allowing the receiver to be used as an accurate instrument for the evaluation of the transmitter's high-resolution phase-shifter.

In an embodiment, a method comprises transmitting a chirp signal as a test signal for a receiver over a loopback path of a radar transceiver; estimating an amplitude and phase of a resultant beat frequency signal in the receiver due to its use of that same chirp signal as its local oscillator (LO), an amplitude and phase of an image of the beat frequency signal, and a magnitude and phase of a DC offset at the receiver; determining an amplitude mismatch correction, a phase mismatch correction, and a DC correction from the estimated amplitude and phase of the beat frequency signal, the image of the beat frequency signal, and the DC offset; and applying the determined amplitude mismatch correction, determined phase mismatch correction, and determined DC correction to subsequent received signals during said receiver's normal operation.

In an embodiment, a system comprises at least one transmitter channel (TX), a chirp generator for transmitting a chirp signal as a test signal for a receiver over a loopback path of the radar transceiver; and at least one receiver channel (RX), each receiver channel including an analog front-end configured to receive the test signal and a digital front-end configured to: estimate an amplitude and phase of a beat frequency signal resulting from the test signal, an amplitude and phase of an image of the beat frequency signal, and an amplitude and phase of a DC offset, determine an amplitude mismatch correction, a phase mismatch correction, and a DC correction from the estimated amplitude and phase of the beat frequency signal, the image signal of the beat frequency signal, and the DC offset, and applying the determined amplitude mismatch correction, the determined phase mismatch correction, and the determined DC correction to subsequent received signals during said receiver channel's normal operation.

In an embodiment, the multiple transmitter TX paths or channels use the same chirp generator, which is the common local oscillator (LO) modulated with a ramp. This same LO is also used in the receiver for down-converting the incoming signal, resulting in the beat frequency signal that depends on how fast the chirp is with respect to the TX-to-RX delay in the loop-back path. The IQMC is calibrated in one receiver and then that same receiver is used to measure/calibrate the phase-shifters of all TX paths.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram of a radar system according to an embodiment;

FIG. 2 is a system diagram of a radar transceiver according to an embodiment;

FIG. 3A is a block diagram of an analog front-end (AFE) of a receiver of the radar transceiver shown in FIG. 2, according to an embodiment;

FIG. 3B illustrates phase relationship between I and Q paths of a receiver, according to an embodiment;

FIG. 4 illustrates a simplified block diagram of a digital front-end (DFE) of a receiver of the radar transceiver shown in FIG. 2, according to an embodiment;

FIG. 5 is a flow chart illustrating a method for compensating for gain and phase mismatches in a receiver of a radar transceiver according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

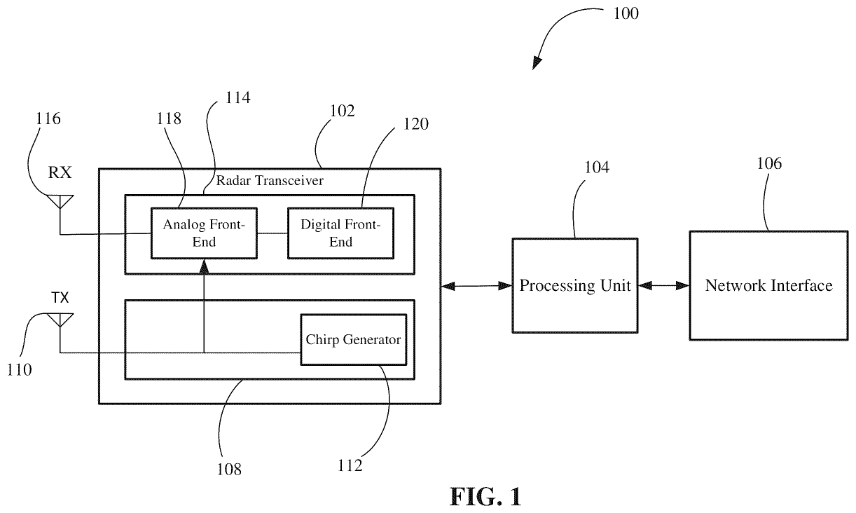

FIG. 1 is a block diagram of a radar system according to an embodiment.

Referring to FIG. 1, a frequency-modulated continuous wave (FMCW) radar system 100 is illustrated. The radar system 100 includes a radar transceiver IC 102, a processing unit 104, and a network interface 106. The radar transceiver IC 102 is coupled to the processing unit 104 via a high-speed serial interface. The radar transceiver IC 102 includes functionality to process multiple digital intermediate frequency (IF) signals (alternatively referred to as dechirped signals, beat signals, or raw radar signals) that are provided to the processing unit 104 via the high speed serial interface. The processing unit 104 includes functionality to perform radar signal processing, i.e., to process the received radar signals to determine, for example, distance, velocity, and angle of any detected objects. The processing unit 104 may also include functionality to perform post processing of the information about the detected objects, such as tracking objects, determining rate and direction of movement, etc. The processing unit 104 provides control information as needed externally via the network interface 106. The network interface 106 may implement any suitable protocol, such as, for example, the controller area network (CAN) protocol, Ethernet protocol, etc.

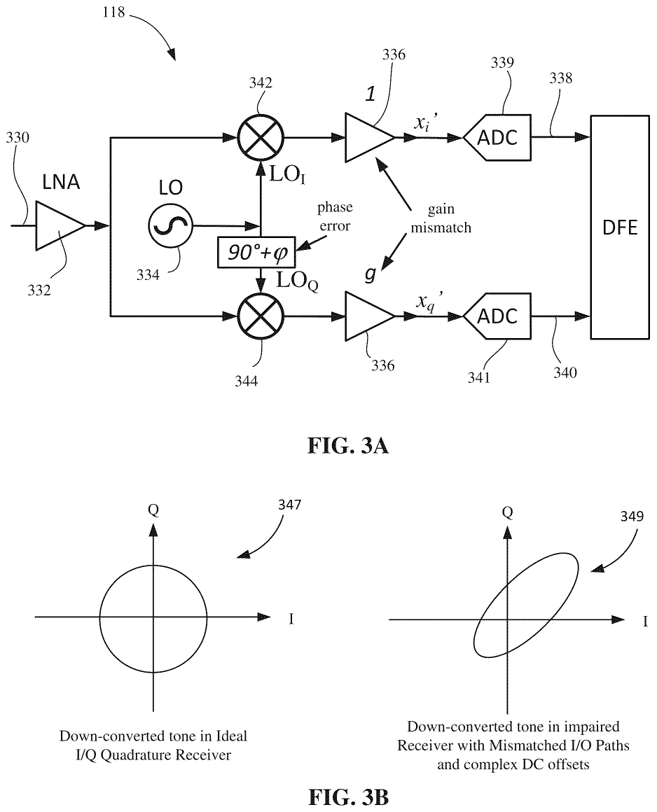

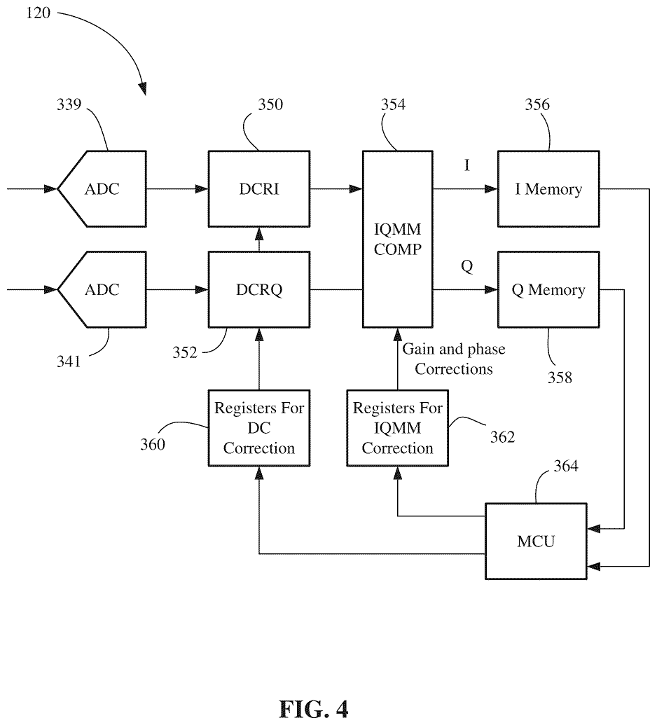

The radar transceiver IC 102 may include multiple transmit channels for transmitting FMCW signals and multiple receive channels for receiving the reflected transmitted signals. A transmit channel includes a suitable transmitter 108 coupled to an antenna 110. Transmitter 108 includes at least a chirp generator 112 and may include other components such as an oscillator, a phase shifter, a power amplifier, etc. A receive channel includes a suitable receiver 114 and antenna 116. Receiver 114 includes an analog front-end (AFE) 118 and a digital front-end (DFE) 120. The AFE 118 will be described in more detail below in relation to FIG. 3 and the DFE 120 will be described in more detail below in relation to FIG. 4.

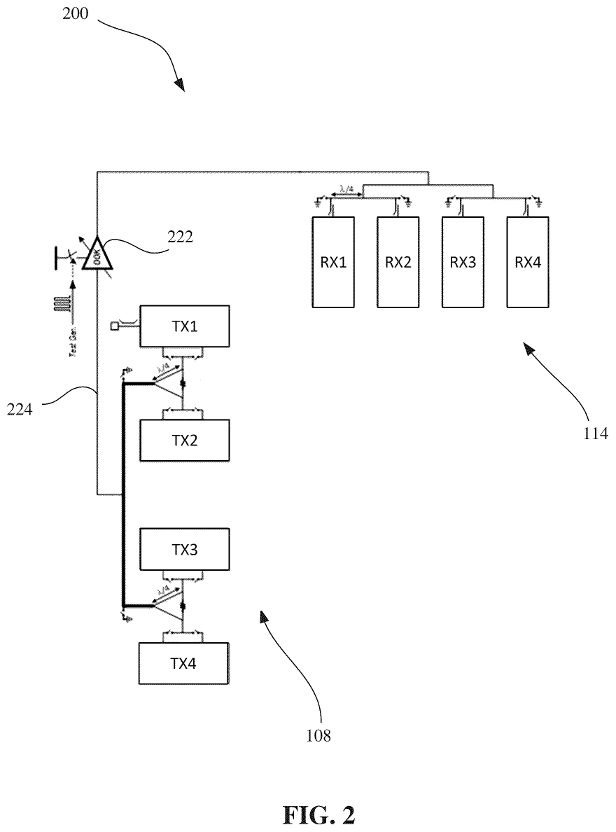

FIG. 2 illustrates a hardware structure 200 for a feedback path employed in IQMC/DCOC calibration, according to an embodiment.

Referring to FIG. 2, one of the transmitters 208 (for instance TX1) is selected and is set to transmit using a power amplifier (PA) output. An FMCW chirp signal is transmitted from the transmitter 208 and is passed to the OOK (on-off keying modulator) circuit 222 via a network of transmission lines 224. There are two different modes of operation of OOK circuit 222 that result in small variation of the algorithms or functions of the present disclosure:

Mode 1: The OOK circuit 22 is set to always-on mode and does not produce any additional modulation.

Mode 2: The OOK circuit 222 is set to produce modulation at frequency f_{OOK}.

An output of the OOK circuit 222 is distributed to all four receivers 114 (e.g., RX1 through RX4). One receiver is chosen to be compensated at a time (e.g., RX1). It may be possible to perform data captures in all four receivers simultaneously, if memory storage at the output of the AFE 118 is sufficient. This will further reduce the calibration time per system.

FIG. 3A illustrates an AFE 118 of receiver RX1, according to an embodiment.

Referring to FIG. 3A, a main RX path 330 of the receiver 118 through a low-noise amplifier (LNA) 332 is illustrated. Two output signals D1(I) 338 and D1(Q) 340 respectively are received at the output of the receiver 118 via ADCs 339, 341 respectively. In some embodiments, 4096 samples of each are captured and stored in memory for processing by a processor. The receiver 118 further includes mixers 342, 34 that are coupled to LNA 332 and chirp generator 334 to down-convert the original chirp signal from transmitter 108 (typically the same oscillator is shared via buffers, rather than a separate one that is synchronized with the transmitter's chirp signal). The mixers 342, 344 produce at their outputs the frequency difference between the LO chirp signal generated by the chirp generator 334 and the delayed version of it that is fed through the TX-to-RX loopback path, and it is this beat-frequency tone that is used for the evaluation of the I/Q mismatches.

In an ideal (i.e. matched) I/Q quadrature receiver this beat frequency tone would appear in both the I and Q paths of the receiver at exactly the same amplitude and with a 900 phase shift between the two. When represented in polar coordinates, i.e. I versus Q, this creates a perfect circle 347, see FIG. 3B. However, mismatches in the gains of the I and Q paths, as well as deviations of the phase relationship between the quadrature LO signals of the receiver from the nominal value of 90°, would result in this polar representation becoming an ellipse 349 instead of a circle, see FIG. 3B. The addition on unpredictable complex DC offset in the receiver shifts the origin of this ellipse accordingly.

FIG. 4 illustrates a simplified block diagram of a digital front-end 120 of a receiver 118, according to an embodiment.

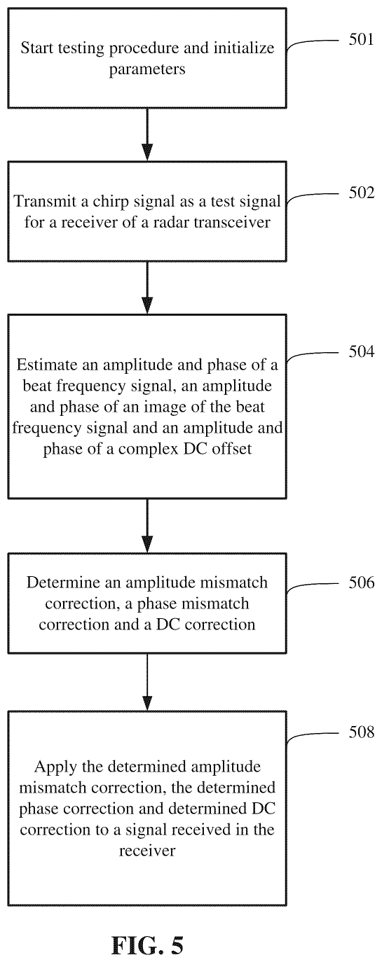

Referring to FIG. 4, the DFE 120 is coupled to the AFE 118 via ADCs 339, 341. The DFE 120 includes a DC removal block for subtracting a DC offset value from the signals in the I and Q paths, e.g., DCRI 350 for the I path and DCRQ 352 for the Q path, an IQMM (IQ Mismatch) compensator 354 that compensates for the IQMM arising from analog IQ mixing, I memory 356, Q memory 358 and a microcontroller (MCU) 364. As will be described in more detail below in relation to FIG. 5, the MCU 364 performs an algorithm or function to determine an IQ mismatch correction and a DC offset correction. The MCU 364 retrieves values from the I memory 356 and Q memory 358 and determines the DC offset correction for each of those two branches (i.e. complex DC offset) and stores same in DC correction registers 360. Additionally, the MCU 364 determines a gain mismatch correction and phase mismatch correction and stores same in IQMM correction registers 362. As signals are output from ADC 339, DC removal block 350 applies the DC offset correction, the IQMM compensator 354 applies the gain mismatch correction and phase mismatch correction and the corrected signals are stored in I memory 356. Similarly, as signals are output from ADC 341, DC removal block 355 applies the DC offset correction, the IQMM compensator 354 applies the gain mismatch correction and phase mismatch correction and the corrected signals are stored in Q memory 358. The corrected signals in I memory 356 and Q memory 358 may then be transmitted to the processing unit 104 for radar signal processing.

Methods for computing IQMM and DC offset will now be described. The methods may be performed in one of the two modes described above, i.e., Mode 1: No OOK modulation of the chirp signal and Mode 2: OOK modulation of the chirp signal. The use of the OOK modulation is intended to frequency-convert the beat-frequency created in the receiver by an amount that would sufficiently distance it from zero, allowing easier separation of the beat-frequency from DC.

A method for computing IQMM and DC Offset without OOK modulation is described below, i.e., mode 1. In some embodiments, the various methods will share a common system model which is described as follows:

A suitable beat-frequency tone at location f, which will be present in the receiver after down-conversion is provided by Equation (1):

$$y ( t ) = cos ( 2 π f t ) + j \{ sin ( 2 π f t ) \} \qquad ( 1 )$$

In Equation (1), the real component of the signal y(t) corresponds to the signal that will be observed and sampled on the I branch of the receiver, while the imaginary component will be observed and sampled on the Q-branch.

The impaired RX signal can be written as shown in Equation (2). It is to be appreciated that the “impaired” signal is the beat frequency tone (i.e. includes the effect of the loop-back delay) as it appears in the I and Q branches. But it is considered “impaired” not due to that delay, but due to the unequal gains in the I and Q branches, as well as the inaccuracy in the 90-degree angle that they would ideally have between them. An additional impairment is the addition of unknown DC offsets on the two RX branches.

$$y ( t ) = cos ( 2 π f t ) + {D}_{R} + j \{ g cos θ sin ( 2 π f t ) + g sin θ cos ( 2 π f t ) + {D}_{I} \} + {n}_{R} ( t ) + j {n}_{I} ( t ) \qquad ( 2 )$$

In Equation (2), g is a gain mismatch, θ is phase mismatch, D_{R} (i.e. real) is DC offset experienced in I branch, D_{I} (i.e. imaginary) is DC offset experienced in Q branch, and the terms n_{R}(t), jn_{I}(t) represent noise observed in the I (Real) and Q (Imaginary) branches respectively.

In the digital domain t=nTₛ, with sampling period of Tₛ, n∈[0, N−1] and n_{R}(t)+jn_{I}(t) represent sampled complex Gaussian noise. It can also be written as shown in Equation (3).

$$y ( t ) = {G}_{1} {e}^{j 2 π f t} + {G}_{2} {e}^{- j 2 π f t} + {D}_{R} + j {D}_{I} + {n}_{R} ( t ) + j {n}_{I} ( t ) \qquad ( 3 )$$

In Equation (3),

$${G}_{1} = \frac{1 + g {e}^{j θ}}{2} , {G}_{2} = \frac{1 - g {e}^{- j θ}}{2} .$$

The fractional frequency with respect to FFT subcarrier spacing is

$${k}_{r e l} = \frac{f}{{F}_{s} / N} = {fNT}_{s} .$$

When fᵣₑₗ is not an integer, there is an issue of fractional frequency with incomplete cycles of the cos/sin functions within the observation period, so the average of the real and imaginary parts of the signal will not be zero, thus complicating the estimation of the IQMM (gain mismatch g and phase mismatch θ) and DC parameters (D_{R}+jD_{I}). This is a likely situation in the radar chirp loopback-based method, where the delay is relatively short.

A method for direct frequency estimation with iterations will now be described. For each iteration,
1) Estimate the frequency of tone assuming IQMM and DC are compensated and noise is low by exploiting the phase ramp relationship in the angle domain. One way to estimate the frequency is given below, but alternatively, a linear regression fit can be applied to the vector of angles per sample and the slope, which would be proportional to the frequency, may be estimated.

$$\hat{f} = \frac{1}{2 π T s} \cdot \frac{1}{N - 1} ( angle ( {y}_{iter} ( ( N - 1 ) \cdot {T}_{s} ) ) - angle ( {y}_{iter} ( 0 ) ) \qquad ( 4 )$$

2) Estimate the IQMM and DC by constructing a least-squares problem using known basis vectors e^{j2π\hat{f}t} and e^{-j2π\hat{f}t} and y as a vector containing y(t) as shown in Equation (5).

$${[ {\hat{G}}_{1} {\hat{G}}_{2} \hat{D} ]}^{T} = arg {min}_{{G}_{1}^{′} , {G}_{2}^{′} , {D}^{′}} {‖ y - [ \begin{matrix}… \\ {e}^{j 2 π \hat{f} n {T}_{s}} {e}^{- j 2 π \hat{f} n {T}_{s}} 1 \\ …\end{matrix} ] * {[ {G}_{1}^{′} {G}_{2}^{′} {D}^{′} ]}^{T} ‖}^{2} \\ \hat{g} = \vert \frac{{\hat{G}}_{1} + {\hat{G}}_{2}^{{}_{{}_{*}}}}{{\hat{G}}_{1} - {\hat{G}}_{2}^{{}_{{}_{*}}}} \vert \hat{θ} = angle 〈 \frac{{\hat{G}}_{1} + {\hat{G}}_{2}^{{}_{{}_{*}}}}{{\hat{G}}_{1} - {\hat{G}}_{2}^{{}_{{}_{*}}}} 〉 \qquad ( 5 )$$

3) Compensate the IQMM and DC in the DFE based on the values estimated in the previous step:

$${y}_{d c r} = y - \overline{D} = {y}_{dcr , R} ( t ) + j {y}_{DCR , I} ( t ) \\ {y}_{iter} ( t ) = {y}_{dcr , R} ( t ) + j ( \frac{1}{\hat{g} cos \hat{θ}} {y}_{dcr , I} ( t ) - tan \hat{θ} {y}_{dcr , R} ( t ) ) \qquad ( 6 )$$

4) Go back to 1) if there are more iterations to execute; otherwise, use the estimated ĝ, \hat{θ}, \hat{D} from the last iteration. The estimated \hat{f} is additional information and can be compared with f to check the accuracy.

A method for estimation with ellipse fitting will now be described.

In the absence of IQMM and DC offset, when plotting a signal phase trajectory, y_{I}(t) versus y_{R}(t), a complex tone would ideally describe a circle (a partial circle if fᵣₑₗ<1), centered at the origin (0,0). The presence of IQMM converts a circle into an ellipse, while DC offset moves the center of the ellipse to a point (D_{R},D_{I}).

The ellipse equation is given below with y(t)=y_{R}(t)+jy_{I}(t), which eliminates the term corresponding to cos(2πft) and sin(2πft) and where the impact of noise is ignored.

$${( {y}_{R} ( t ) - {D}_{R} )}^{2} + {( \frac{{y}_{I} ( t ) - {D}_{I} - g sin θ {y}_{R} ( t )}{g cos θ} )}^{2} = 1 \\ {g}^{2} {cos}^{2} {θ ( {y}_{R} ( t ) - {D}_{R} )}^{2} + {( {y}_{I} ( t ) - {D}_{I} - g sin θ {y}_{R} ( t ) )}^{2} = {g}^{2} {cos}^{2} θ \\ {g}^{2} {{y}_{R} ( t )}^{2} - 2 g sin θ {y}_{R} ( t ) {y}_{I} ( t ) - 2 {D}_{I} {y}_{I} ( t ) + 2 ( {D}_{I} g sin θ - {D}_{R} {g}^{2} {cos}^{2} θ ) {y}_{R} ( t ) + ( {D}_{R}^{2} - 1 ) {g}^{2} {cos}^{2} θ + {D}_{I}^{2} = - {{y}_{I} ( t )}^{2} \qquad ( 7 )$$

Construct the estimation vector with transformed parameters as shown in Equation (8).

$$ψ = [ {g}^{2} , - 2 g sin θ , 2 ( {D}_{I} g sin θ - {D}_{R} {g}^{2} {cos}^{2} θ ] , \qquad ( 8 )$$

$${- 2 {D}_{I} , ( {D}_{R}^{2} - 1 ) {g}^{2} {cos}^{2} θ + {D}_{I}^{2} ]}^{T} .$$

Then, write a least-squares problem to estimate ψ as shown in Equation (9).

$$\overline{ψ} = arg {min}_{ψ} , {‖ u - Y {ψ}^{′} ‖}^{2} . \qquad ( 9 )$$

In Equation (9), the matrix Y has rows consisting of [y_{R}(t)²,y_{R}(t)y_{I}(t),y_{R}(t),y_{I}(t),1] and u is a vector consisting of −y_{I}(t)².

The estimated IQMM and DC parameters are then extracted from \hat{ψ}—

$$\hat{θ} = a sin ( - 0.5 \cdot \overline{ψ} ( 2 ) / \hat{g} ) \\ \hat{g} = \sqrt{\overline{ψ} ( 1 )} \\ = - 0.5 \cdot \hat{ψ} ( 4 ) \\ = \frac{\hat{g} sin \hat{θ} - 0.5 \cdot \hat{ψ} ( 3 )}{{\hat{g}}^{2} {cos}^{2} \hat{θ}} \qquad ( 10 )$$

### Mode 2: (With OOK Modulation)

The two methods for computing IQMM and DC Offset in Mode 2 are now provided, which have a common system model that can be described as follows:

Find all samples of z(t) that are positive:

An ideal beat-frequency tone at location f, which will be present in the receiver after down-conversion, is shown in Equation (11).

$$x ( t ) = cos ( 2 π ft ) + j \{ sin ( 2 π ft ) \} \qquad ( 11 )$$

This signal is also modulated by the OOK signal as shown in Equation (12).

$$z ( t ) = sign ( cos ( 2 π {f}_{OOK} t ) ) = {\sum }_{k = 1}^{∞} {a}_{k} cos ( 2 π ( 2 k - 1 ) {f}_{OOK} t ) \qquad ( 12 )$$

It should be noted that the practical OOK signal does not toggle between +1 and −1, as with a symmetrical modulating square wave, but rather between +1 and 0 (i.e. on/off switching), but this does not affect the mathematical analysis that follows.

Resulting in a signal as shown in Equation (13).

$$y ( t ) = z ( t ) ( cos ( 2 π ft ) + j \{ sin ( 2 π ft ) \} ) \qquad ( 13 )$$

In Equation (13), the real component of the signal y(t) corresponds to the signal that will be observed and sampled on the I branch of the receiver, while the imaginary component will be observed and sampled on the Q-branch.

The impaired RX signal can be written as shown in Equation (14).

$$y ( t ) = z ( t ) cos ( 2 π ft ) + {D}_{R} + j \{ z ( t ) [ g cos θ sin ( 2 π ft ) + g sin θ cos ( 2 π ft ) ] + {D}_{I} \} + {n}_{R} ( t ) + {jn}_{I} ( t ) \qquad ( 14 )$$

In Equation (14), g is a gain mismatch, θ is phase mismatch, D_{R} is DC offset experienced in I branch, D_{I} is DC offset experienced in Q branch, and the terms n_{R}(t), jn_{I}(t) represent noise observed in the I (Real) and Q (Imaginary) branches respectively.

In the digital domain t=nTₛ, with sampling period of Tₛ, n∈[0,N−1] and n_{R}(t)+jn_{I}(t) represent sampled complex Gaussian noise. It can also be written as shown in Equation (15).

$$y ( t ) = z ( t ) {G}_{1} {e}^{j 2 π ft} + z ( t ) {G}_{2} {e}^{- j 2 π ft} + {D}_{R} + {jD}_{I} + {n}_{R} ( t ) + {jn}_{I} ( t ) \qquad ( 15 )$$

In Equation (15),

$${G}_{1} = \frac{1 + g {e}^{j θ}}{2} , {G}_{2} = \frac{1 - g {e}^{- j θ}}{2} .$$

The frequency content of the resulting signal will have components at ±f offset from all odd (positive and negative) multiples of f_{OOK}. Therefore, f_{OOK} would be preferably placed at an integer multiple of an FFT bin to simplify the detection in the receiver.

Another method for direct frequency estimation with iterations will now be described. For each iteration,
1) Estimate the frequency of tone assuming IQMM and DC are compensated and the noise is low by exploiting the phase ramp relationship in the angle domain. Here the phase ramp will be reversing directions with frequency f_{OOK}. Therefore, the direction of the ramp must be reversed with this frequency. Afterwards, interpolation of phase is used to estimate \hat{f}.
2) Estimate the IQMM and DC by constructing a least-squares problem using known basis vectors z(t)e^{j2π\hat{f}t} and z(t)e_{-j2π\hat{f}t} and y as a vector containing y(t).

$${[ {\hat{G}}_{1} {\hat{G}}_{2} \hat{D} ]}^{T} = arg {min}_{{G}_{1}^{′} , {G}_{2}^{′} , {D}^{′}} {‖ y - [ \begin{matrix}⋯ \\ \begin{matrix}z ( t ) {e}^{j 2 π \hat{f} {nT}_{s}} & z ( t ) {e}^{- j 2 π \hat{f} {nT}_{s}} & 1\end{matrix} \\ ⋯\end{matrix} ] * [ {G}_{1}^{′} {G}_{2}^{′} {D}^{′} ] ‖}^{2} \qquad ( 16 )$$

$$\hat{g} = \vert \frac{{\hat{G}}_{1} + {\hat{G}}_{2}^{*}}{{\hat{G}}_{1} - {\hat{G}}_{2}^{*}} \vert$$

$$\hat{θ} = angle 〈 \frac{{\hat{G}}_{1} + {\hat{G}}_{2}^{*}}{{\hat{G}}_{1} - {\hat{G}}_{2}^{*}} 〉$$

3) Compensate the IQMM and DC similar to the DFE design.

$${y}_{dcr} = y - D = {y}_{dcr , R} ( t ) + {jy}_{DCR , I} ( t ) \qquad ( 17 )$$

$${y}_{iter} ( t ) = {y}_{dcr , R} ( t ) + j ( \frac{1}{\hat{g} cos \hat{θ}} {y}_{dcr , I} ( t ) - tan \hat{θ} {y}_{dcr , R} ( t ) )$$

4) Go back to 1) if there are more iterations to execute, otherwise use the estimated ĝ, \hat{θ}, \hat{D} from the last iteration. The estimated \hat{f} is additional information and can be compared with f to check the accuracy.

A method for estimation with ellipse fitting will now be described.

It is well known that in the absence of IQMM and DC offset, when plotting a signal phase trajectory, y_{I}(t) versus y_{R}(t), a complex tone will appear as a circle (a partial circle if fᵣₑₗ<1), centered at the origin (0,0), see circle 347 in FIG. 3B. In the presence of IQMM the circle would be replaced by an ellipse, while DC offset shifts the center of the ellipse to a point (D_{R}, D_{I}), see ellipse 349 in FIG. 3B

In addition, modulation by the OOK envelope z(t) will mask (i.e. chop) portions of the ellipse at a frequency of f_{OOK}. Therefore, only samples corresponding to where z(t)=1 should be selected and the samples taken while z(t)=0 are to be discarded.

Thus, only the samples taken during the “ON” period of the OOK envelope are considered, while the approximately fifty percent of samples corresponding to the “OFF” period are discarded. To enable this selection, the receiver must identify when the incoming signal is in its ON or OFF state. This may be achieved in one of two ways: (1) through a synchronization mechanism in which the same signal used to modulate the transmitter with the OOK envelope is also provided to the receiver for timing reference; or (2) through a correlation-based detection operation performed by the receiver, wherein the receiver determines the periods of the OOK envelope by correlating the received signal with a reference pattern and identifying when the correlation output attains its peak value. Either approach allows the receiver to accurately select the valid samples corresponding to z(t)=1 prior to applying the ellipse-fitting estimation process.

The ellipse equation is given below with y(t)=y_{R}(t)+jy_{I}(t), which eliminates the term corresponding to cos(2πft) and sin(2πft) and where the impact of noise is ignored.

$${( {y}_{R} ( t ) - {D}_{R} )}^{2} + {( \frac{{y}_{I} ( t ) - {D}_{I} - g sin θ {y}_{R} ( t )}{g cos θ} )}^{2} = 1 \qquad ( 18 )$$

$${g}^{2} {cos}^{2} {θ ( {y}_{R} ( t ) - {D}_{R} )}^{2} + {( {y}_{I} ( t ) - {D}_{I} - g sin θ {y}_{R} ( t ) )}^{2} = {g}^{2} {cos}^{2} θ$$

$${g}^{2} {{y}_{R} ( t )}^{2} - 2 g sin θ {y}_{R} ( t ) {y}_{I} ( t ) - 2 {D}_{I} {y}_{I} ( t ) + 2 ( {D}_{I} g sin θ - {D}_{R} {g}^{2} {cos}^{2} θ ) {y}_{R} ( t ) + ( {D}_{R}^{2} - 1 ) {g}^{2} {cos}^{2} θ + {D}_{I}^{2} = - {{y}_{I} ( t )}^{2}$$

Construct the estimation vector with transformed parameters as shown in Equation (19).

$$ψ = {[ {g}^{2} , - 2 g sin θ , 2 ( {D}_{I} g sin θ - {D}_{R} {g}^{2} {cos}^{2} θ ) , - 2 {D}_{I} , ( {D}_{R}^{2} - 1 ) {g}^{2} {cos}^{2} θ + {D}_{I}^{2} ]}^{T} \qquad ( 19 )$$

Then, write a least-squares problem to estimate ψ as shown in Equation (20).

$$\hat{ψ} = arg {min}_{{ψ}^{′}} , {‖ u - Y {ψ}^{′} ‖}^{2} \qquad ( 20 )$$

In Equation (20), the matrix Y has rows consisting of [y_{R}(t)²,y_{R}(t)y_{I}(t),y_{R}(t),y_{I}(t),1] and u is a vector consisting of −y_{I}(t)².

Finally, the estimated IQMM and DC params are extracted from \hat{ψ} as shown in Equation (21).

$$\hat{θ} = asin ( - 0.5 \cdot \hat{ψ} ( 2 ) / \hat{g} ) \qquad ( 21 )$$

$$\hat{g} = \sqrt{\hat{ψ} ( 1 )}$$

$$= - 0.5 \cdot \hat{ψ} ( 4 )$$

$$= \frac{\hat{{D}_{I}} \hat{g} sin \hat{θ} - 0.5 \cdot \hat{ψ} ( 3 )}{{\hat{g}}^{2} cos \hat{θ}}$$

Other ways of constructing the least-squares problem are also possible by adjusting the basis vectors in Y and corresponding transformed parameters ψ and vector u. Moreover, any other pattern matching algorithm can be deployed to fit the geometric shape of the locus of the constellation in two-dimensional I/Q space (e.g., defining alternate metrics such as geometric distance minimization to candidate ellipses).

FIG. 5 is a flow chart illustrating a method for calibrating and compensating a receiver of a radar transceiver according to an embodiment of the present disclosure.

In step 501, the built-in self-testing procedure is started and certain parameters are initialized. For example, amplitude and filtering settings of I and Q channels in receiver being evaluated are calibrated. The low pass filter (LPF) of I and Q branches are set to a high corner frequency so as not to suppress the down-converted signal of interest.

Additionally, the high pass filter (HPF) of the I and Q channels are set depending on the testing mode selected. For example,

Mode 1: Set HPF in both channels to lowest frequency. This is intended to maximize the power of the tone of interest at the ADC input and its ratio to DC offset of ADC. This is to be used when the method without OOK modulation is implemented.

Mode 2: Set HPF in both channels to a frequency that passes the OOK frequency but rejects the dc and low frequencies associated with direct ‘spillover’ from the transmitter to the receiver (i.e. bypassing the OOK path). This is to be used when the method with OOK modulation is implemented (the preferred embodiment, expected to be more robust).

Furthermore, the transmitter 108 is set to chirp mode with widest BW available and highest chirp slope (i.e., to be able to resolve short delays) and the test mode is set, i.e., Mode 1: Set OOK modulator to ‘always on’ and Mode 2: Set OOK modulator to produce square pulse at a rate f_{OOK}.

In step 502, the transmitter 108 generates a chirp signal via the chirp generator 112 and transmits the chirp signal as a test signal for the receiver 118 of the transceiver 102, while the loopback path is enabled. The receiver 114 demodulates the chirp signal and captures N samples of I and Q (e.g., N=4096).

In step 504, the MCU 364 of the receiver 114 estimates an amplitude and phase of a beat frequency, an amplitude and phase of an image of the beat frequency and an amplitude and phase of a complex DC offset.

In step 506, the MCU 364 determines ĝ—gain mismatch, \hat{θ}—phase mismatch, \hat{D}_{R}—DC offset experienced in I branch, \hat{D}_{I}—DC offset experienced in Q branch via Method 1 (i.e., direct frequency estimation function with iterations) or Method 2 (i.e., a least squares estimation function based on elliptical fitting with a single iteration) described above.

In step 508, the determined gain, phase and DC offset corrections are applied to DFE registers 360, 362. Equation (22) is for applying the correction (wherein coefficients to be used in DFE 120 are

$$\frac{1}{\hat{g} cos \hat{θ}}$$

and tan \hat{θ}):

$${y}_{corr} ( t ) = {y}_{R} ( t ) - \hat{{D}_{R}} + j ( \frac{1}{\hat{g} cos \hat{θ}} ( {y}_{I} ( t ) - \hat{{D}_{I}} ) - tan \hat{θ} ( {y}_{R} ( t ) - \hat{{D}_{R}} ) ) \qquad ( 22 )$$

Alternatively, the methods 1 and 2, with and without OOK modulation (Mode 1 and Mode 2) can be applied to discover amplitude and phase of multiple tones located at kᵣₑₗ<f_{SCS} or at non-integer multiples of f_{SCS}, when kᵣₑₗ>f_{SCS} also DC offset can be obtained simultaneously.

It is to be appreciated that in direct frequency estimation function with iterations, i.e., Method 1, approximately 50 iterations are required for best IRR performance. However, in a further embodiment, the following technique may be employed to speed up the estimation function in Method 1. On iteration one, compute [symbol] as described in direct frequency estimation procedure followed by estimation of gain, phase mismatch and complex DC. On iterations 2 through 10, compute [symbol] as described above, then adjust [symbol] using:

$$= \hat{{f}_{ι ter}} + k ( \hat{{f}_{ι ter}} - ) \qquad ( 23 )$$

followed by estimation of gain, phase mismatch and complex DC. For a value of k=4, a 10-iteration performance equals final 50-iteration performance of the unmodified algorithm.

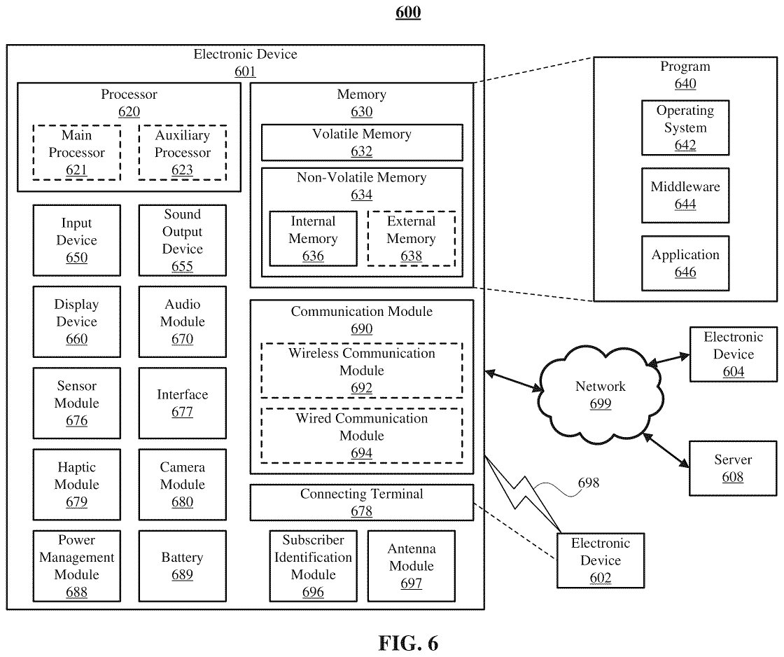

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations, e.g., as illustrated in FIG. 5.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

A “non-transitory computer-readable medium” as used herein refers to any storage medium that retains data even after power is removed or the device is shut down. Some examples of “non-transitory computer-readable medium” are a hard drive, optical disc, a flash drive, etc.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
transmitting a chirp signal as a test signal for a receiver over a loopback path of a radar transceiver;
estimating an amplitude and phase of a beat frequency signal, an amplitude and phase of an image of the beat frequency signal, and an amplitude and phase of a DC offset at the receiver;
determining an amplitude mismatch correction, a phase mismatch correction, and a DC correction from the estimated amplitude and phase of the beat frequency signal, the image of the beat frequency signal, and the DC offset; and
applying the determined amplitude mismatch correction, determined phase mismatch correction, and determined DC correction to subsequent received signals during said receiver's normal operation.

2. The method of claim 1, further comprising modulating the chirp signal with an on-off keying (OOK) signal operating at a predetermined frequency.

3. The method of claim 1, wherein the estimating is performed using a direct frequency estimation function with iterations.

4. The method of claim 3, wherein the direct frequency estimation function includes:
estimating a frequency of the beat frequency signal;
estimating the amplitude mismatch correction, the phase mismatch correction, and the DC correction based on the estimated frequency using a least squares estimation function; and
iteratively estimating the amplitude mismatch correction, the phase mismatch correction and the DC correction.

5. The method of claim 1, wherein the estimating is performed using a least squares estimation function based on elliptical fitting with a single iteration.

6. The method of claim 5, wherein the least squares estimation function based on elliptical fitting comprises discarding samples corresponding to an off state of an OOK modulation envelope and performing the estimation using only samples taken while the modulation envelope is on.

7. The method of claim 6, wherein the receiver determines the on and off states of the OOK modulation envelope by receiving a synchronization signal corresponding to the OOK modulation applied to the transmitted chirp signal.

8. The method of claim 6, wherein the receiver determines the on and off states of the OOK modulation envelope by performing a correlation operation between the received signal and a reference pattern and selecting sample intervals corresponding to a maximum correlation value.

9. A radar transceiver comprising:
at least one transmitter channel;
a chirp generator for transmitting a chirp signal as a test signal for a receiver over a loopback path of the radar transceiver; and
at least one receiver channel, each receiver channel including an analog front-end configured to receive the test signal and a digital front-end configured to:
estimate an amplitude and phase of a beat frequency signal resulting from the test signal, an amplitude and phase of an image of the beat frequency signal, and an amplitude and phase of a DC offset,
determine an amplitude mismatch correction, a phase mismatch correction, and a DC correction from the estimated amplitude and phase of the beat frequency signal, the image signal of the beat frequency signal, and the DC offset, and
applying the determined amplitude mismatch correction, the determined phase mismatch correction, and the determined DC correction to subsequent received signals during said receiver channel's normal operation.

10. The radar transceiver of claim 9, further comprising an on-off keying (OOK) circuit for modulating the chirp signal with an OOK signal operating at a predetermined frequency.

11. The radar transceiver of claim 9, wherein the at least one receiver channel is configured to perform the estimating using a direct frequency estimation function with iterations.

12. The radar transceiver of claim 11, wherein the direct frequency estimation function includes:
estimating a frequency of the beat frequency signal;
estimating the amplitude mismatch correction, the phase mismatch correction, and the DC correction based on the estimated frequency using a least squares estimation function; and
iteratively estimating the amplitude mismatch correction, the phase mismatch correction and the DC correction.

13. The radar transceiver of claim 9, wherein the at least one receiver channel is configured to perform the estimating using a least squares estimation function based on elliptical fitting with a single iteration.

14. The radar transceiver of claim 13, wherein the least squares estimation function based on elliptical fitting includes discarding samples corresponding to an off state of an OOK modulation envelope and performing the estimation using only samples taken while the modulation envelope is on.

15. The radar transceiver of claim 14, wherein the at least one receiver channel determines the on and off states of the OOK modulation envelope by receiving a synchronization signal corresponding to the OOK modulation applied to the transmitted chirp signal.

16. The radar transceiver of claim 14, wherein the at least one receiver channel determines the on and off states of the OOK modulation envelope by performing a correlation operation between the received signal and a reference pattern and selecting sample intervals corresponding to a maximum correlation value.

17. A non-transitory computer-readable medium storing instructions, when executed by a radar transceiver, cause the radar transceiver to perform the steps of:
transmitting a chirp signal as a test signal for a receiver over a loopback path of a radar transceiver;
estimating an amplitude and phase of a beat frequency signal, an amplitude and phase of an image of the beat frequency signal, and an amplitude and phase of a DC offset at the receiver;
determining an amplitude mismatch correction, a phase mismatch correction, and a DC correction from the estimated amplitude and phase of the beat frequency signal, the image of the beat frequency signal, and the DC offset; and
applying the determined amplitude mismatch correction, determined phase mismatch correction, and determined DC correction to subsequent received signals during said receiver's normal operation.

18. The non-transitory computer-readable medium of claim 17, wherein the instructions, when executed by the radar transceiver, further cause the radar transceiver to perform the steps of modulating the chirp signal with an on-off keying (OOK) signal operating at a predetermined frequency.

19. The non-transitory computer-readable medium of claim 17, wherein the instructions, when executed by the radar transceiver, further cause the radar transceiver to perform the estimating using a direct frequency estimation function with iterations.

20. The non-transitory computer-readable medium of claim 19, wherein the instructions, when executed by the radar transceiver, further cause the radar transceiver to perform the direct frequency estimation function including:
estimating a frequency of the beat frequency signal;
estimating the amplitude mismatch correction, the phase mismatch correction, and the DC correction based on the estimated frequency using a least squares estimation function; and
iteratively estimate the amplitude mismatch correction, the phase mismatch correction and the DC correction.

21. The non-transitory computer-readable medium of claim 17, wherein the instructions, when executed by the radar transceiver, further cause the radar transceiver to perform the estimating using a least squares estimation function based on elliptical fitting with a single iteration.

22. The non-transitory computer-readable medium of claim 21, wherein the least squares estimation function based on elliptical fitting comprises discarding samples corresponding to an off state of an OOK modulation envelope and performing the estimation using only samples taken while the modulation envelope is on.

23. The non-transitory computer-readable medium of claim 22, wherein the instructions, when executed by the radar transceiver, further cause the radar transceiver to determine the on and off states of the OOK modulation envelope by receiving a synchronization signal corresponding to the OOK modulation applied to the transmitted chirp signal.

24. The non-transitory computer-readable medium of claim 22, wherein the instructions, when executed by the radar transceiver, further cause the radar transceiver to determine the on and off states of the OOK modulation envelope by performing a correlation operation between the received signal and a reference pattern and selecting sample intervals corresponding to a maximum correlation value.
